(19) United States
(12) Patent Application Publication
(10) Pub. No.: US 2015/0094908 A1
(43) Pub. Date: Apr. 2, 2015

(54) LASER RADAR APPARATUS

(71) Applicants: Satoshi Hirota, Aichi (JP); Daisuke Itao, Aichi (JP)

(72) Inventors: Satoshi Hirota, Aichi (JP); Daisuke Itao, Aichi (JP)

(73) Assignee: OMRON AUTOMOTIVE ELECTRONICS CO., LTD., Aichi (JP)

(21) Appl. No.: 14/504,056

(22) Filed: Oct. 1, 2014

(30) Foreign Application Priority Data
Oct. 1, 2013 (JP) 2013-206038

(51) Int. Cl. B60S 1/08; G01S 17/95

(52) U.S. Cl. CPC B60S 1/0833; G01S 17/95
USPC 701/36

(57) ABSTRACT

A laser radar apparatus includes a beam projecting unit and a beam receiving unit that receives via a glass surface a reflective wave occurring when a beam projected from the beam projecting unit is reflected from an object. The laser radar apparatus further includes control unit that commands a prompt operation mode of a wiper when an amount of the objects is determined to be greater than or equal to a threshold level based on a beam reception level detected by the beam receiving unit, and a wiper operation control unit that controls the wiper to operate in the prompt operation mode after a waiting time period elapses. The waiting time period is from when it is detected that the amount of the objects is greater than or equal to the threshold level to when a wiper operation starts.

### CROSS-REFERENCE TO RELATED APPLICATIONS

This application claims priority from Japanese Patent Application No. 2013-206038 filed on Oct. 1, 2013, the entire contents of which are incorporated herein by reference.

### FIELD

The disclosure relates to a laser radar apparatus, particularly, to a laser radar apparatus that can control a wiper operation to be executed at an appropriate time.

### BACKGROUND

In the related art, typically, an on-vehicle radar apparatus is widely used which detects a traveling direction, or a distance between a vehicle and a vehicle in a passing lane or between a vehicle and an object, and controls the operation of the vehicle based on the detected distance.

The radar apparatus operates based on a principle in which a beam projecting unit projects beams to a monitoring region, reflective beams reflected from an object in the monitoring region are received, and a distance to the object is acquired based on beam projecting time and beam receiving time. For example, JP-A-2012-242218 discloses an on-vehicle laser radar apparatus that can efficiently acquire information of a target in a detection range when a detection executable range is appropriately set.

In recent years, a vehicle is equipped with a rain sensor that detects the amount of raindrops based on the level of beams reflected from the raindrops attached to a glass surface of the vehicle, and that has an automatic wiper function of automatically operating a wiper when the detected amount of raindrops exceeds a certain value. A rain sensor technology is developed by which the level of beams reflected from raindrops is detected, and the raindrops attached to a surface of a front windshield glass are also detected via a camera image or the like, and thus the wiper is automatically controlled.

### SUMMARY

However, since the above-mentioned rain sensors cannot detect raindrops until the raindrops are attached to the glass surface, there is a delay until a wiper operation starts. For this reason, for example, when a truck passes by the vehicle, and splashes a large amount of water over the vehicle, it is difficult to execute control for effectively wiping away water. When the glass surface is uniformly wet with a large amount of raindrops, it is not possible to detect the raindrops, or the detection of the raindrops is delayed. Accordingly, for example, it is necessary to detect the raindrops colliding with the glass surface in advance, and control a wiper operation to be executed at an appropriate time.

The disclosure is made in light of the problems, and in the disclosure, it is possible to control a wiper operation to be executed at an appropriate time.

A laser radar apparatus according to an aspect of the disclosure includes a beam projecting unit that projects a pulse-shaped beam to an outside of a vehicle from an inside of the vehicle via a glass surface; a beam receiving unit that is installed at a position separated from the beam projecting unit in a substantially horizontal direction, and receives via the glass surface a reflective wave occurring when the beam projected from the beam projecting unit is reflected from an object; a control unit that commands a prompt operation mode of a wiper which wipes the glass surface when an amount of the objects is determined to be greater than or equal to a given level based on a beam reception level detected by the beam receiving unit; and a wiper operation control unit that controls the wiper to operate in the prompt operation mode after a waiting time period elapses, the waiting time period being from when it is detected that the amount of the objects is greater than or equal to the given level to when a wiper operation starts.

In the aspect of the disclosure, the pulse-shaped beam is projected to the outside of the vehicle from the inside of the vehicle via the glass surface. The beam receiving unit is installed at the position separated from the beam projecting unit in the substantially horizontal direction, and receives via the glass surface the reflective wave occurring when the beam projected from the beam projecting unit is reflected from the object. When the amount of the objects is greater than or equal to a given level based on the beam reception level detected by the beam receiving unit, the control unit commands the prompt operation mode of the wiper. The wiper operation control unit controls the wiper to operate in the prompt operation mode after the waiting time period elapses. The waiting time period is from when it is detected that the amount of the objects is greater than or equal to the given level to when the wiper operation starts.

According to the aspect of the disclosure, it is possible to control a wiper operation to be executed at an appropriate time.

### BRIEF DESCRIPTION OF THE DRAWINGS

FIG. 1 is a view illustrating an example of an exterior configuration of a vehicle equipped with a laser radar apparatus according to an embodiment of the present invention;

FIG. 2 is an exterior perspective view of the laser radar apparatus in FIG. 1 when seen from a front upper side;

FIG. 3 is an exterior perspective view of the laser radar apparatus when seen from a front upper side;

FIG. 4 is a left side cross-sectional view of the laser radar apparatus in FIG. 2 when facing FIG. 2;

FIG. 5 is a front view of the laser radar apparatus;

FIG. 6 is a top view illustrating the disposition of a beam projecting unit, a beam receiving unit, and a raindrop sensor;

FIG. 7 is an enlarged right side view illustrating the disposition of the beam projecting unit, the beam receiving unit, and the raindrop sensor;

FIG. 8 is an enlarged left side view illustrating the disposition of the beam projecting unit, the beam receiving unit, and the raindrop sensor;

FIG. 9 is a functional block diagram describing a system configuration of a vehicle equipped with the laser radar apparatus in FIG. 2;

FIG. 10 is a functional block diagram describing an example of the configuration to realize the functions of the laser radar apparatus in FIG. 2;

FIG. 11 is a functional block diagram describing an example of the configuration of the raindrop sensor;

FIG. 12 is a view describing a detection range of the raindrop sensor;

FIG. 13 is a flow chart describing a raindrop detection wiper control process;

FIG. 14 is a flow chart describing a raindrop detecting process;

FIGS. 15A and 15B are views describing how to determine if there are raindrops;

FIG. 16 is a flow chart describing an operation start determination process;

FIG. 17 is a flow chart describing an operation level determination process;

FIG. 18 is a flow chart describing an operation stop determination process;

FIG. 19 is a flow chart describing a prompt operation process;

FIG. 20 is a flow chart describing an intermittent time period adjusting process;

FIG. 21 is a flow chart describing a rainfall evaluation process;

FIG. 22 is a flow chart describing a wiper operation control process; and

FIG. 23 is a flow chart describing an example of the configuration of a versatile personal computer.

### DETAILED DESCRIPTION

Hereinafter, a specific embodiment of the present technology will be described in detail with the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### Example of Configuration of Laser Radar Apparatus

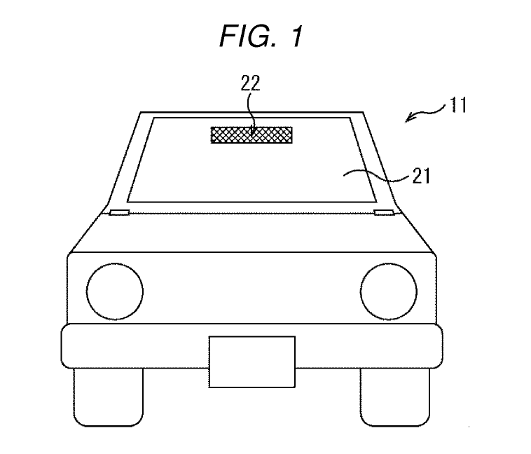

FIG. 1 is a view illustrating an example of an exterior configuration of a vehicle equipped with a laser radar apparatus according to an embodiment of the present invention. In a vehicle 11 illustrated in FIG. 1, a laser radar apparatus 22 is mounted on an inner side (e.g., in a passenger compartment) of front windshield glass 21, and is positioned on a back side of a rearview mirror (not illustrated). The laser radar apparatus 22 projects beams to a monitoring region in front of the vehicle 11, and receives reflective beams that are reflected from an object in the monitoring region. The laser radar apparatus 22 measures a distance to the object based on beam projecting time and beam receiving time. In FIG. 1, the laser radar apparatus 22 is mounted on the inner side of the front windshield glass 21, and is positioned on the back side of the rearview mirror (not illustrated). However, insofar as the laser radar apparatus 22 is positioned in the passenger compartment, and can project and receive beams from the inner side of the front windshield glass, the mounting position of the laser radar apparatus 22 is not limited to the inner side of the front windshield glass 21, and the laser radar apparatus 22 may be installed on an inner side of a rear window or a side window.

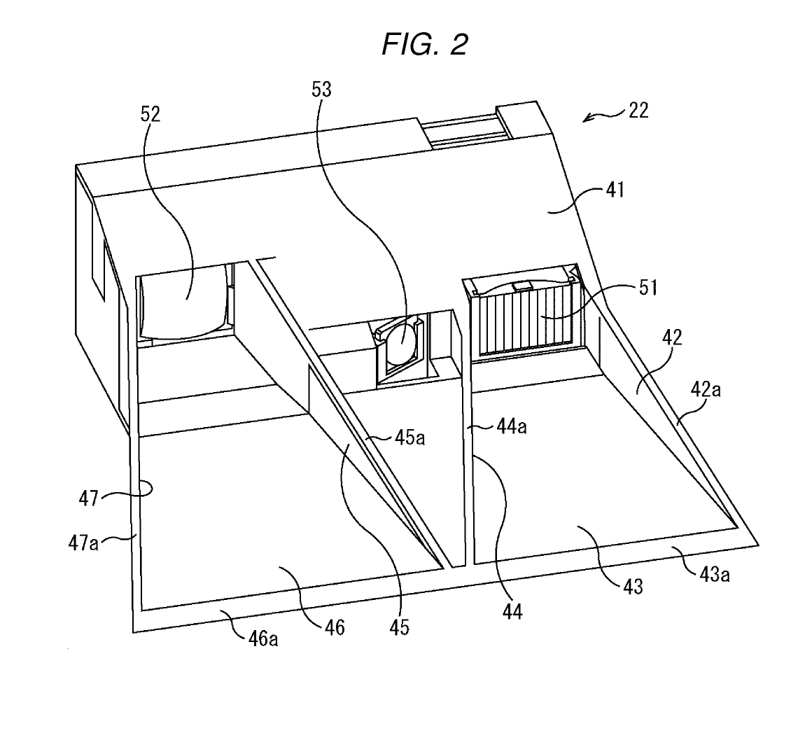

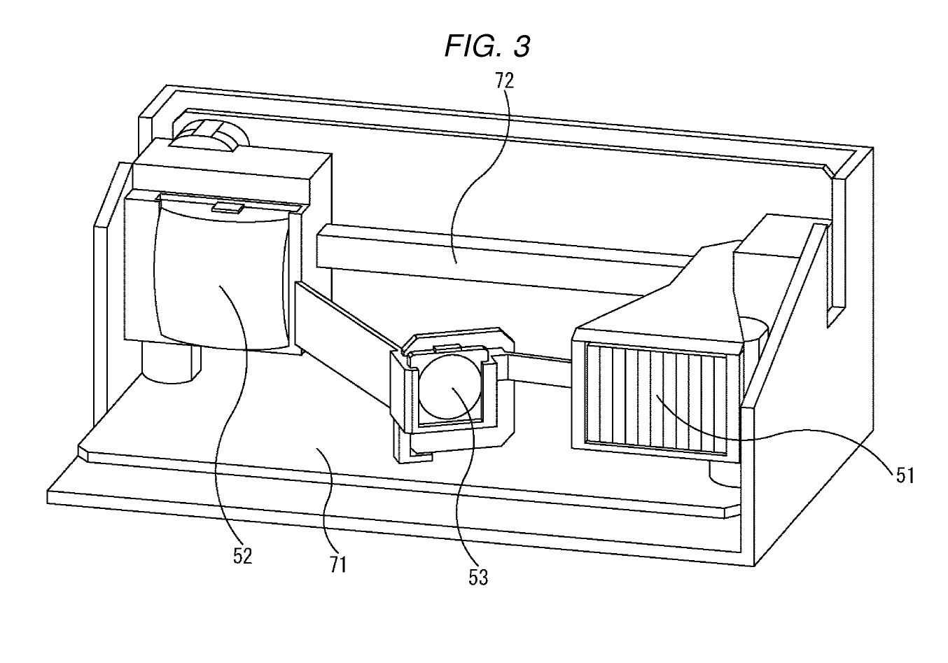

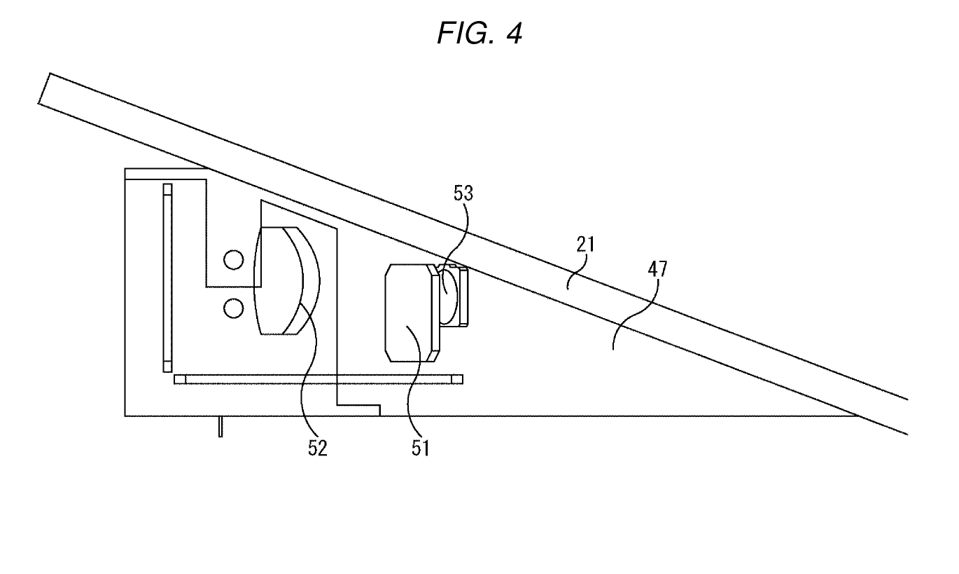

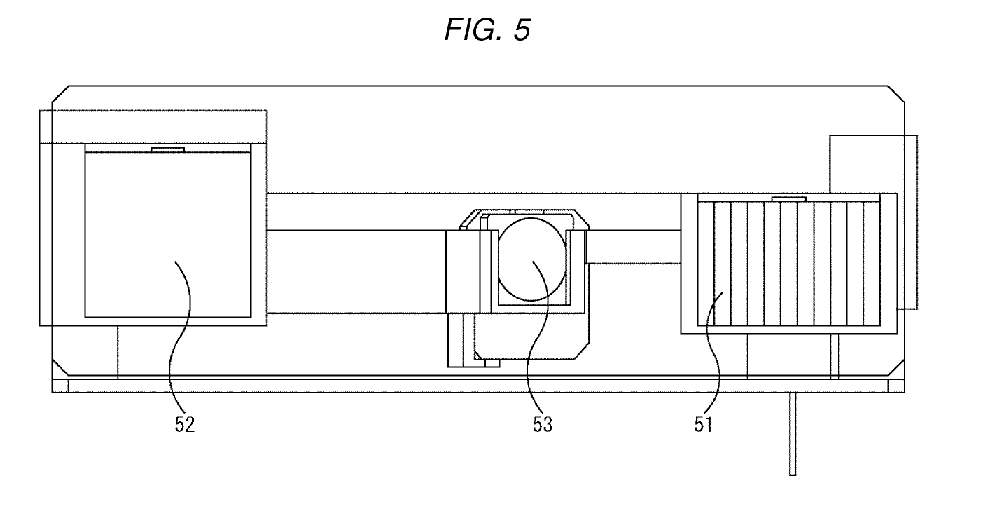

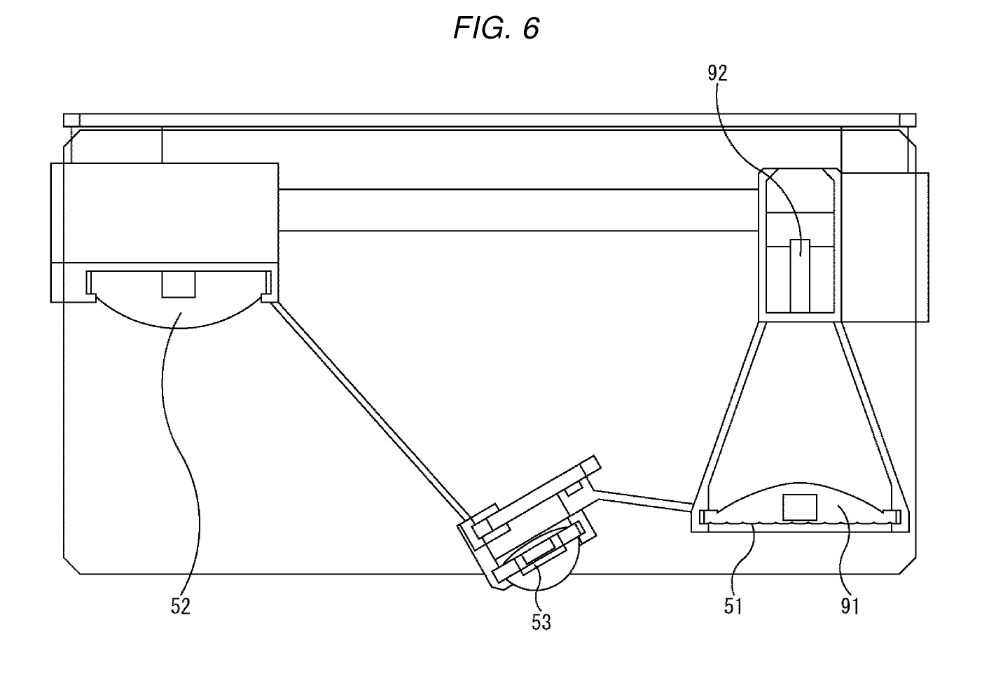

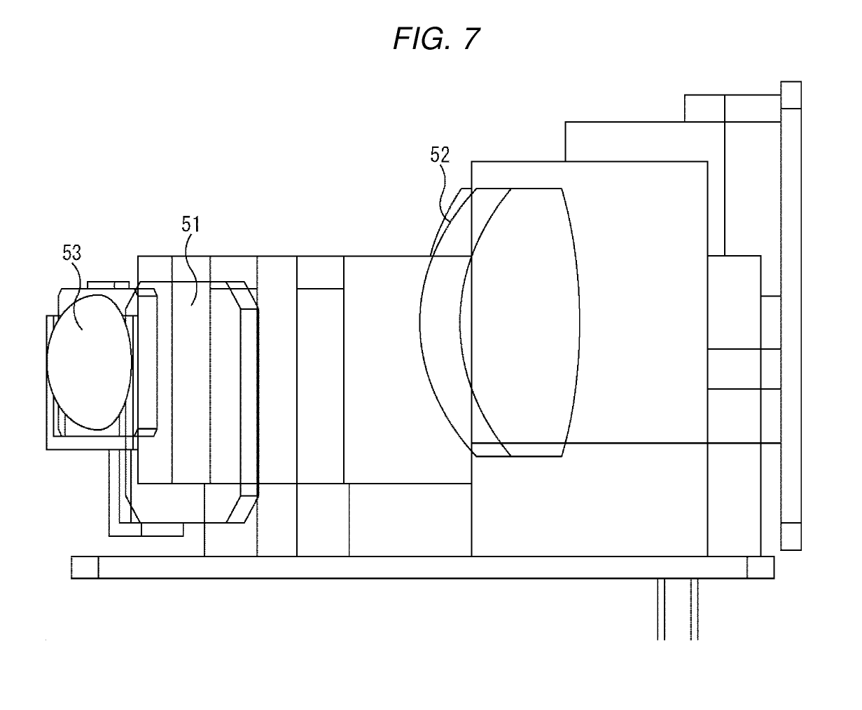

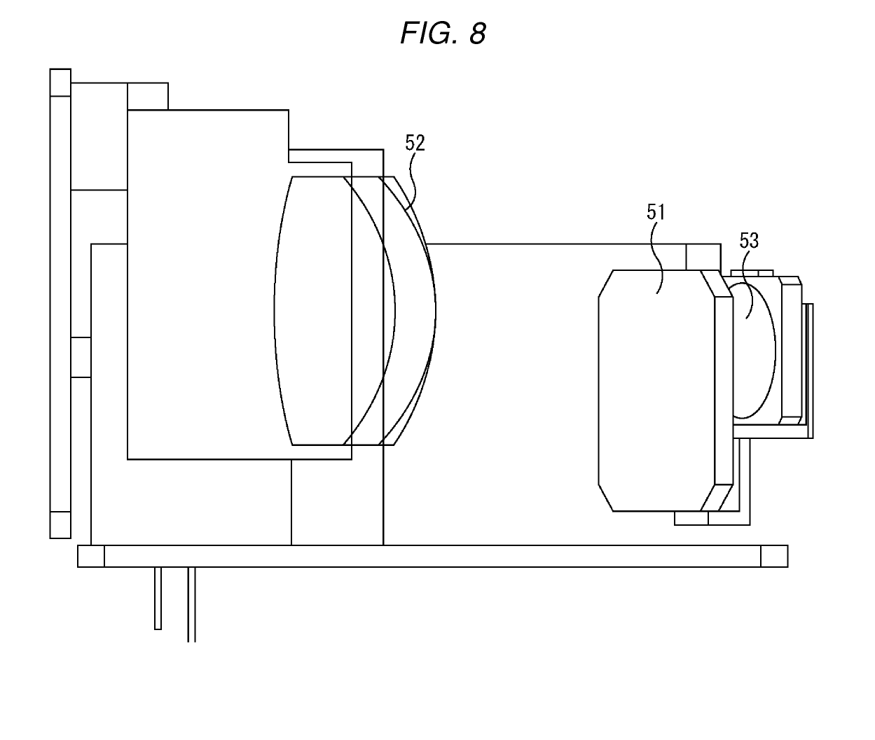

FIGS. 2 to 8 are views illustrating the example of the configuration of the laser radar apparatus 22. More specifically, FIG. 2 is an exterior perspective view of the laser radar apparatus 22 when seen from a front upper side. FIG. 3 is a perspective view illustrating the disposition of a beam projecting unit 51, a beam receiving unit 52, and a raindrop sensor 53 when a cover 41 is detached from the laser radar apparatus 22 illustrated in FIG. 2. FIG. 4 is a left side cross-sectional view of the laser radar apparatus 22 illustrated in FIG. 2 when facing FIG. 2. FIG. 5 is an enlarged view illustrating the periphery of the raindrop sensor 53 with the raindrop sensor 53 in FIG. 3 facing the front. FIG. 6 is a top view illustrating the disposition of the beam projecting unit 51, the beam receiving unit 52, and the raindrop sensor 53 in FIG. 3. FIGS. 7 and 8 are enlarged right and left side views of FIG. 3, respectively, illustrating the disposition of the beam projecting unit 51, the beam receiving unit 52, and the raindrop sensor 53 in FIG. 3.

In the exterior configuration of the laser radar apparatus 22, the beam projecting unit 51, the beam receiving unit 52, and the raindrop sensor 53 are covered with the cover 41, and only the following portions are opened: an opening portion for beam projection of the beam projecting unit 51; an opening portion for beam reception of the beam receiving unit 52; and an opening portion for the detection of raindrops of the raindrop sensor 53. The monitoring region of the laser radar apparatus 22 is positioned in a forward direction in FIG. 2. For this reason, the beam projecting unit 51 generates beams and projects the beams toward the forward direction, and the beam receiving unit 52 receives reflective beams occurring when the beams projected from the beam projecting unit 51 are reflected from an object present in the forward direction. As illustrated in FIG. 3, the beam projecting unit 51, the beam receiving unit 52, and the raindrop sensor 53 are electrically connected to each other via a substrate 71. The beam projecting unit 51, the beam receiving unit 52, and the raindrop sensor 53 are fixed to a frame 72, and vibrations of the vehicle and the like cannot change relative positions therebetween.

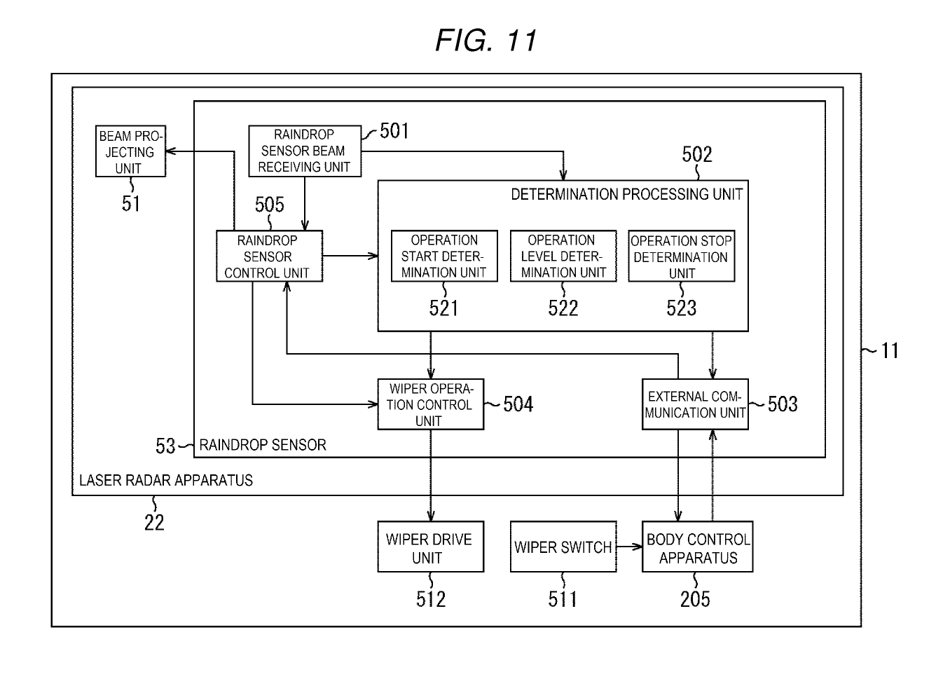

For example, when pulse-shaped lasers projected from the beam projecting unit 51 are reflected from raindrops and the like in a predetermined range positioned forward from the front windshield glass 21, the raindrop sensor 53 detects the amount of raindrops based on the reception of the reflective beams. For example, the raindrop sensor 53 controls the drive of a wiper (not illustrated) based on the amount of raindrops detected. The configuration of the raindrop sensor 53 will be described later with reference to FIG. 11. In this example, the raindrop sensor 53 is disposed in a space between the beam projecting unit 51 and the beam receiving unit 52. However, it is possible to provide a camera, a solar radiation sensor, or the like in the space instead of the raindrop sensor 53.

As illustrated in FIGS. 2, 3, 5, and 6, since the beam projecting unit 51, the beam receiving unit 52, and the raindrop sensor 53 are disposed substantially linearly in a horizontal direction when seen from a forward direction, it is possible to reduce the vertical thickness of the laser radar apparatus 22. As a result, since it is possible to install the laser radar apparatus 22 between the rearview mirror and the front windshield glass 21, and minimize a region that is obstructive to the visibility of a driver, it is possible to secure a wide visibility in the front windshield glass 21.

As illustrated in FIGS. 2, 3, and 6 to 8, the raindrop sensor 53 is provided so as to protrude furthest forward, the beam projecting unit 51 is provided at a second front position, and the beam receiving unit 52 is provided at a furthest rearward position. In this configuration, the beam receiving unit 52 is unlikely to directly receive beams projected from the beam projecting unit 51, and thus it is possible to reduce noise occurring when the beam receiving unit 52 directly receives the beams projected from the beam projecting unit 51. The raindrop sensor 53 present between the beam projecting unit 51 and the beam receiving unit 52 functions as a partition, and it is possible to prevent the beam receiving unit 52 from directly receiving beams that are reflected from the front windshield glass 21 among beams projected from the beam projecting unit 51. As a result, it is possible to reduce noise occurring when the beam receiving unit 52 directly receives beams projected from the beam projecting unit 51.

A beam shield wall 42 is provided in a left side plane (a right side plane in FIG. 2) along a left end portion when the monitoring region is seen from the beam projecting unit 51. Among the beams projected from the beam projecting unit 51, the beam shield wall 42 shields or reflects scattered beams that advance leftwards (a right direction in FIG. 2) from a side plane (the right side plane in FIG. 2) which is a left limit of the monitoring region when seen from the beam projecting unit 51; or reflective beams that are reflected from the front windshield glass 21 or the like due to an unknown reason and advance leftwards from the side plane which is the left limit of the monitoring region.

A beam shield wall 44 is provided in a right side plane (a left side plane in FIG. 2) along a right end portion when the monitoring region is seen from the beam projecting unit 51. Among the beams projected from the beam projecting unit 51, the beam shield wall 44 shields or reflects scattered beams that advance rightwards (a left direction in FIG. 2) from a side plane (the left side plane in FIG. 2) which is a right limit of the monitoring region when seen from the beam projecting unit 51; or reflective beams that are reflected from the front windshield glass 21 or the like due to an unknown reason and advance rightwards from the side plane which is the right limit of the monitoring region.

A beam shield bottom 43 is provided along a plane of a lower end portion when the monitoring region is seen from the beam projecting unit 51. The beam shield bottom 43 is provided in a plane that is a lower limit of the monitoring region of the beam projected from the beam projecting unit 51 when seen from the beam projecting unit 51. The beam shield bottom 43 reflects beams, which are reflected from the front windshield glass 21 among beams projected from the beam projecting unit 51, in a direction in which the monitoring region is present, or shields the reflected beams. That is, since the beam shield bottom 43 has a surface that inclines downwards from the forward direction in FIG. 2, even when beams projected from the beam projecting unit 51 are reflected from the front windshield glass 21, and are incident on the beam shield bottom 43, the beams are reflected forwards where the monitoring region is present. Accordingly, it is possible to prevent the beam receiving unit 52 from directly receiving the beams reflected from the front windshield glass 21.

A beam shield wall 45 is provided in a left side plane (a right side plane in FIG. 2) along a left end portion when the monitoring region is seen from the beam receiving unit 52. Among beams reflected from an object in the monitoring region, the beam shield wall 45 shields scattered beams that the beam receiving unit 52 may receive from a leftward side (a rightward side in FIG. 2) of a side plane (a right side plane in FIG. 2) which is a left limit of the monitoring region when seen from the beam receiving unit 52; or reflective beams that may be reflected from the front windshield glass 21 or the like due to an unknown reason and that the beam receiving unit 52 may receive from the left side plane of the monitoring region.

A beam shield wall 47 is provided in a right side plane (a left side plane in FIG. 2) along a right end portion when the monitoring region is seen from the beam receiving unit 52. Among beams reflected from an object in the monitoring region, the beam shield wall 47 shields scattered beams that the beam receiving unit 52 may receive from a rightward side (a leftward side in FIG. 2) of a side plane (the left side plane in FIG. 2) which is a right limit of the monitoring region when seen from the beam receiving unit 52; or reflective beams that may be reflected from the front windshield glass 21 or the like due to an unknown reason and that the beam receiving unit 52 may receive from the right side surface of the monitoring region.

A beam shield bottom 46 is provided along a plane of a lower end portion when the monitoring region is seen from the beam receiving unit 52. The beam shield bottom 46 is provided in a plane that is a lower limit of the monitoring region when seen from the beam receiving unit 52. The beam shield bottom 46 causes the beam receiving unit 52 to receive only reflective beams that are incident from the direction in which the monitoring region is present. That is, since the beam shield bottom 46 has a surface that inclines downwards from the forward direction in FIG. 2, even when beams are reflected from an object in the monitoring region and are incident on the beam shield bottom 46, the beams are reflected from the beam shield bottom 46, and thus the beam receiving unit 52 can receive the beams.

That is, since the beam shield walls 42 and 44 and the beam shield bottom 43 are provided in front of the opening portion through which the beam projecting unit 51 projects beams, and form a dustpan shape to shield or reflect the beams, the beam projecting unit 51 can reliably project the beams to only the monitoring region.

That is, since the beam shield walls 45 and 47 and the beam shield bottom 46 are provided in front of the opening portion through which the beam receiving unit 52 receives beams, and form a dustpan shape to shield the beams, the beam receiving unit 52 can reliably receive beams that are reflected from only an object in the monitoring region among beams projected from the beam projecting unit 51.

As a result, it is possible to reduce noise occurring when the beam receiving unit 52 directly receives beams projected from the beam projecting unit 51.

As illustrated in FIGS. 2 and 4, respective contact surfaces 42a, 44a, 45a, and 47a of the beam shield walls 42, 44, 45, and 47 to be in contact with the front windshield glass 21 are substantially parallel with the front windshield glass 21, and respective contact surfaces 43a and 46a of the beam shield bottoms 43 and 46 to be in contact with the front windshield glass 21 are substantially parallel with the front windshield glass 21. For this reason, it is possible to install the laser radar apparatus 22 on the back side of the rearview mirror (not illustrated) and on the inner side of the front windshield glass 21 with a main body of the laser radar apparatus 22 in close contact with the front windshield glass 21.

As a result, the beam projecting unit 51 can reliably project beams to only the monitoring region due to the beam shield walls 42 and 44 and the beam shield bottom 43. Similarly, the beam receiving unit 52 can receive beams that are reflected from only an object in the monitoring region among beams projected from the beam projecting unit 51 due to the beam shield walls 45 and 47 and the beam shield bottom 46. Since the combination of the above-mentioned configurations enables the beam projecting unit 51 to reliably project beams to only the monitoring region, and the beam receiving unit 52 to receive beams reflected from only an object in the monitoring region, it is possible to reduce noise occurring when the beam receiving unit 52 directly receives the beams projected from the beam projecting unit 51, and accurately measure a distance to the object.

As illustrated in FIG. 6, the beam projecting unit 51 is provided with a beam projecting circuit 92 that is formed by a laser diode LD generating laser beams, and a beam projecting optical system 91 that converts the laser beams generated by the beam projecting circuit 92 into beams which are respectively parallel with a plurality of directions.

### Example of Configuration of Vehicle System Equipped with Laser Radar Apparatus

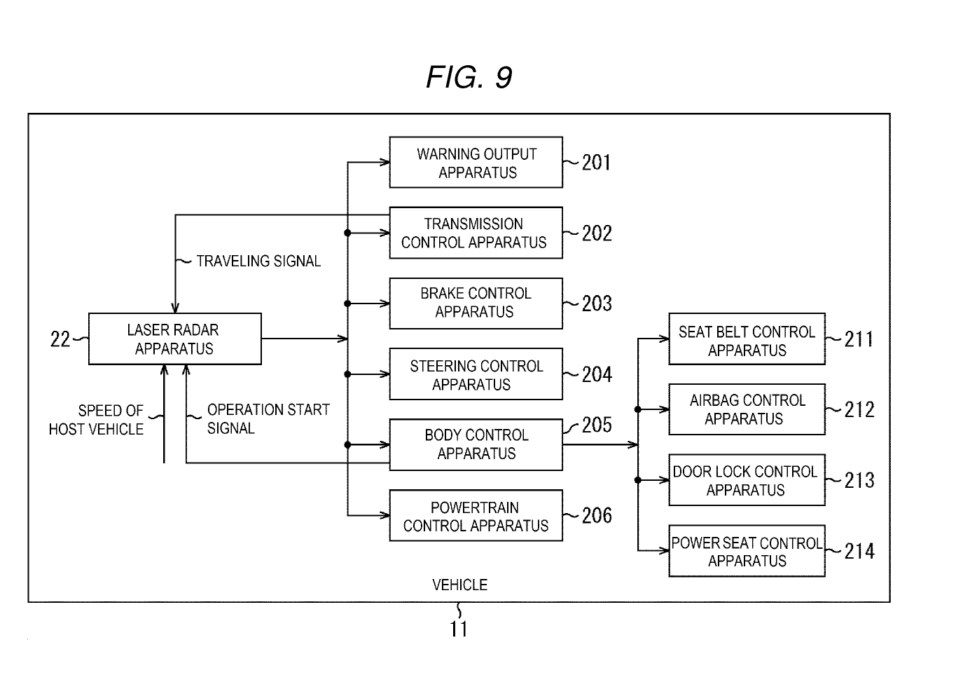

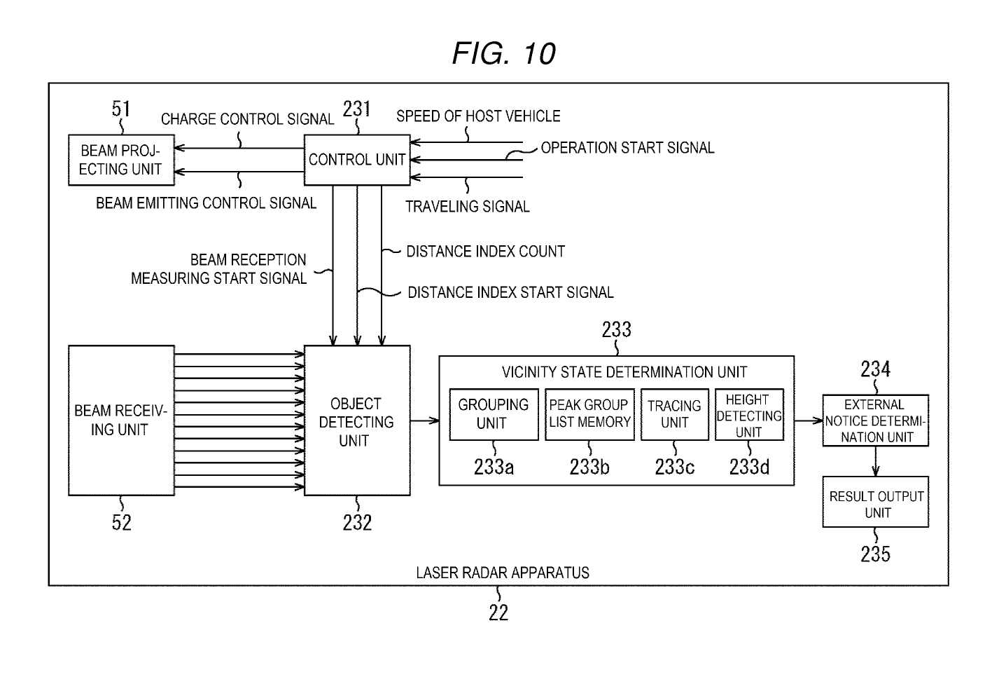

Subsequently, an example of the configuration of the vehicle 11 (a vehicle system of the vehicle 11) equipped with the laser radar apparatus 22 will be described with reference to FIG. 9. The configuration of the laser radar apparatus 22 will be described in detail later with reference to FIG. 10, and the description of the configuration of the laser radar apparatus 22 will be omitted from the description of FIG. 9.

The vehicle 11 includes the laser radar apparatus 22; a warning output apparatus 201; a transmission control apparatus 202; a brake control apparatus 203; a steering control apparatus 204; a body control apparatus 205; a powertrain control apparatus 206; a seat belt control apparatus 211; an airbag control apparatus 212; a door lock control apparatus 213; and a power seat control apparatus 214.

The warning output apparatus 201 outputs warning information in the form of an image on a display (not illustrated), a voice via a speaker (not illustrated), the turning-on of a warning lamp (not illustrated), or the like, based on the warning information from the laser radar apparatus 22. That is, for example, when the laser radar apparatus 22 detects an object (including a preceding vehicle, an obstacle, a pedestrian, or the like) in the monitoring region, foresees that the vehicle may encounter danger, for example, the vehicle may collide with or come into contact with the object, and supplies the corresponding warning information, the warning output apparatus 201 outputs a warning corresponding to the warning information in the form of an image on the display (not illustrated), a voice via the speaker (not illustrated), the turning-on of the warning lamp (not illustrated), or the like, and thus warns the driver that the occurrence of danger is foreseen. Since this process allows the driver to perceive the possibility of an occurrence of danger such as a collision in advance when the vehicle is traveling, the driver can take an action to prevent the collision or to reduce an impact of the collision.

The transmission control apparatus 202 controls a transmission (not illustrated) based on the operation of a paddle shift (not illustrated) or a gear shift knob (not illustrated) by the driver. The transmission control apparatus 202 controls the transmission (not illustrated) based on information supplied from the laser radar apparatus 22. In a case where a cruise control in the traveling vehicle is instructed to follow a preceding vehicle, for example, when the laser radar apparatus 22 detects the preceding vehicle, and supplies control information corresponding to a distance to the detected preceding vehicle so as to maintain a predetermined distance between the host vehicle and the preceding vehicle, the transmission control apparatus 202 controls the transmission to increase or decrease the speed of the vehicle as necessary in collaboration with the brake control apparatus 203 and the powertrain control apparatus 206.

In this process, when the cruise control is set to follow the preceding vehicle while maintaining a predetermined distance, and a distance between the host vehicle and the preceding vehicle is greater than the set distance, the transmission control apparatus 202 controls the transmission to a gear ratio required for acceleration. In contrast, when a distance between the host vehicle and the preceding vehicle is less than the set distance, the transmission control apparatus 202 controls the transmission to decrease the speed of the vehicle via an engine brake in collaboration with the brake control apparatus 203. As a result, the vehicle can travel while maintaining an appropriate distance between the host vehicle and the preceding vehicle.

The brake control apparatus 203 controls a brake operation in response to the operation of a brake pedal (not illustrated) by the driver. The brake control apparatus 203 controls a brake operation based on brake control information supplied from the laser radar apparatus 22. That is, when the laser radar apparatus 22 supplies brake control information to control the brake pedal (not illustrated) based on a distance to the detected object (including a preceding vehicle, an obstacle, a pedestrian, or the like), the brake control apparatus 203 controls a brake operation based on the brake control information. For example, when the laser radar apparatus 22 determines that the host vehicle may be highly likely to collide with a preceding vehicle, based on distance information of the object, and supplies brake control information required for an emergency stop, the brake control apparatus 203 controls the brake pedal (not illustrated) to reduce the speed of the vehicle or stop the vehicle. Even when the driver is in a panicked state due to a potential collision, it is possible to reduce an impact of the collision or prevent the collision right before the collision occurs due to this process.

The steering control apparatus 204 controls the steering angle of a steering wheel (not illustrated) based on steering control information supplied from the laser radar apparatus 22. For example, when the laser radar apparatus 22 determines that the host vehicle may be highly likely to collide with a preceding vehicle, based on distance information of the object, and supplies brake control information to activate an emergency brake operation, the steering control apparatus 204 reads the steering angle of the steering wheel (not illustrated) of the vehicle 11, determines whether the vehicle 11 may spin when the emergency brake operation is activated, based on the current speed of the vehicle, a moving direction of a vehicle body (detected by an acceleration sensor which is not illustrated), and the like, and controls the steering angle of the steering wheel to prevent the occurrence of the spin. In this process, even when the emergency brake operation is activated, it is possible to prevent the vehicle 11 from spinning, and safely stop the vehicle 11.

When the body control apparatus 205 determines whether the vehicle 11 is in an operation state, based on the operation of an ignition button (not illustrated) or the operation of an ignition key, and detects that the vehicle 11 is in an operation state, the body control apparatus 205 supplies an operation start signal to the laser radar apparatus 22. The body control apparatus 205 controls the seat belt control apparatus 211 that controls the winding of a seat belt (not illustrated); the airbag control apparatus 212 that controls the operation of an airbag (not illustrated); the door lock control apparatus 213 that controls a door lock (not illustrated); and the power seat control apparatus 214 that controls a power seat (not illustrated), based on body control information supplied from the laser radar apparatus 22. For example, when the laser radar apparatus 22 determines that the host vehicle may be highly likely to collide with a preceding vehicle, based on distance information of the object, and supplies the corresponding body control information, the body control apparatus 205 controls the seat belt control apparatus 211 to wind the seat belt (not illustrated) based on the body control information, and when a collision occurs, the body control apparatus 205 controls the airbag control apparatus 212 to operate an airbag (not illustrated) at an appropriate time. When the collision occurs, the body control apparatus 205 controls the door lock control apparatus 213 to lock the door lock (not illustrated) of the vehicle 11 at an appropriate time, and then, when it is detected that the vehicle body does not move (detected by the acceleration sensor which is not illustrated) and an engine (not illustrated) stops based on the current speed of the vehicle 11, the body control apparatus 205 unlocks the door lock. When the collision occurs, the body control apparatus 205 controls the power seat control apparatus 214 in such a manner that a power seat (not illustrated) is operated at an appropriate time so as to be moved to a position in which an appropriately reduced impact is exerted on an occupant when the airbag (not illustrated) is operated, and when the stop of the engine (not illustrated) is detected, the power seat is operated so as to allow the occupant to safely to escape from the vehicle 11.

Even when a collision occurs, this process allows a reduced load to be exerted on the occupant via the respective operations of the seat belt (not illustrated), the airbag (not illustrated), and the power seat (not illustrated). Since the locking of the door lock prevents a door from being released when a collision accident occurs, it is possible to prevent the occupants including the driver from being expelled out of the vehicle 11. Since the unlocking of the door lock releases the door after the vehicle 11 stops, the occupants can quickly escape or be rescued.

The powertrain control apparatus 206 controls the rotational speed of the powertrain such as the engine (not illustrated) and a motor (not illustrated) based on powertrain control information from the laser radar apparatus 22. For example, when the laser radar apparatus 22 determines that the host vehicle may be highly likely to collide with a preceding vehicle based on distance information of the object, and supplies the corresponding powertrain control information, the powertrain control apparatus 206 reduces the rotational speed of the powertrain, and thus reduces an impact of the collision. Even when the driver is in a panicked state due to a potential collision, it is possible to reduce an impact of the collision clue to this process.

### Example of Configuration of Laser Radar Apparatus

Subsequently, an example of the configuration of the laser radar apparatus 22 will be described with reference to FIG. 10.

The laser radar apparatus 22 includes the beam projecting unit 51; the beam receiving unit 52; a control unit 231; an object detecting unit 232; a vicinity state determination unit 233; an external notice determination unit 234; and a result output unit 235.

The control unit 231 controls the respective operations of the beam projecting unit 51 and the object detecting unit 232 based on an operation start signal that corresponds to the speed of the host vehicle supplied from a speed measurement apparatus (not illustrated) or an operation state of the ignition button or the ignition key, and based on a traveling signal that indicates whether the host vehicle is traveling based on an operation state of the vehicle detected by a motion sensor (not illustrated) or the like.

The control unit 231 generates a charge control signal that instructs the beam projecting unit 51 to be charged with electrical power required for beam projection, and thus the beam projecting unit 51 is instructed to be charged with electrical power. The control unit 231 generates a beam emitting control signal, thereby controlling a time of emitting beams.

The control unit 231 supplies a beam reception measuring start signal for instructing the start of a detection of an object, a distance index start signal that indicates a time of starting a distance index count, and a distance index count to the object detecting unit 232, and controls the operation of the object detecting unit 232.

The object detecting unit 232 generates peak information that indicates the distance of the object for a direction of each beam reception signal supplied from the beam receiving unit 52, based on the beam reception measuring start signal, the distance index start signal, and the distance index count from the control unit 231, and supplies the peak information to the vicinity state determination unit 233.

The vicinity state determination unit 233 includes a grouping unit 233a; a peak group list memory 233b; a tracing unit 233c; and a height detecting unit 233d. The vicinity state determination unit 233 controls the grouping unit 233a in such a manner that the grouping unit 233a groups the peak information for indicating the respective distances of the object for the directions, based on the distances and the directions, generates peak group lists, and stores the peak group lists in the peak group list memory 233b. The peak group list is formed by a current list and the last list. The vicinity state determination unit 233 controls the tracing unit 233c and the height detecting unit 233d, and completes the current peak group list based on the last peak group list.

The external notice determination unit 234 acquires the peak group lists stored in the peak group list memory 233b of the vicinity state determination unit 233, determines whether it is necessary to send notices to external apparatuses such as the warning output apparatus 201, the transmission control apparatus 202, the brake control apparatus 203, the steering control apparatus 204, the body control apparatus 205, and the powertrain control apparatus 206, and instructs the result output unit 235 to output notices based on determination results.

The result output unit 235 outputs various notices to various external apparatuses based on the determination results from the external notice determination unit 234.

### Example of Configuration of Raindrop Sensor

Subsequently, an example of the configuration of the raindrop sensor 53 will be described with reference to FIG. 11.

The raindrop sensor 53 includes a raindrop sensor beam receiving unit 501; a determination processing unit 502; an external communication unit 503; a wiper operation control unit 504; and a raindrop sensor control unit 505. The vehicle 11 includes a wiper switch 511 and a wiper drive unit 512 in addition to the body control apparatus 205 that has been described with reference to FIG. 9. FIG. 11 illustrates only the beam projecting unit 51 among functional blocks of the laser radar apparatus 22.

For example, the raindrop sensor beam receiving unit 501 has an avalanche photodiode (APD) that outputs a signal corresponding to the amount of received beams in a region in which the amount of received beams is relatively small. The raindrop sensor beam receiving unit 501 receives reflective waves of pulse-shaped laser beams projected from the beam projecting unit 51, and supplies a beam reception level which indicates the amount of received beams, to the determination processing unit 502 and the raindrop sensor control unit 505.

The determination processing unit 502 has an operation start determination unit 521; an operation level determination unit 522; and an operation stop determination unit 523, and executes various determination processes required for the raindrop sensor 53 to operate the wiper. The operation start determination unit 521 executes an operation start determination process so as to determine whether to start a wiper operation. The operation level determination unit 522 executes an operation level determination process so as to determine a wiper operation mode based on an operation level. The operation stop determination unit 523 executes an operation stop determination process so as to determine whether to stop a wiper operation.

The external communication unit 503 executes processes so as to allow the raindrop sensor control unit 505 and the determination processing unit 502 to communicate with an external apparatus. For example, the external communication unit 503 acquires a state (ON/OFF) of the wiper switch 511 via a communication with the body control apparatus 205, and notifies the raindrop sensor control unit 505 of the state. The external communication unit 503 notifies the body control apparatus 205 of a determination result of the determination processing unit 502.

The wiper operation control unit 504 controls a wiper operation via the control of the wiper drive unit 512 based on a process result of the raindrop sensor control unit 505 and a determination result of the determination processing unit 502.

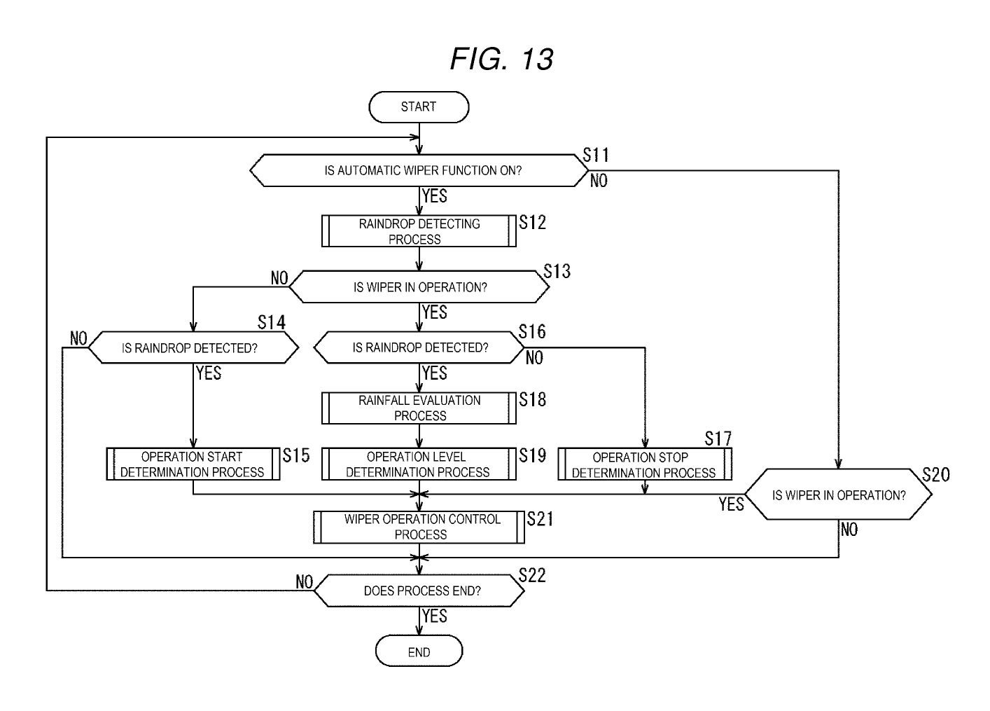

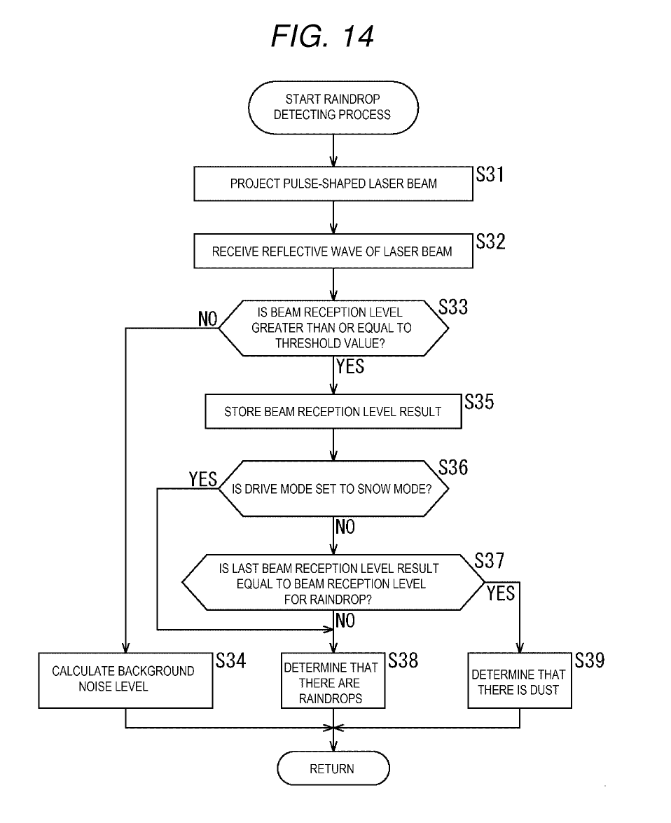

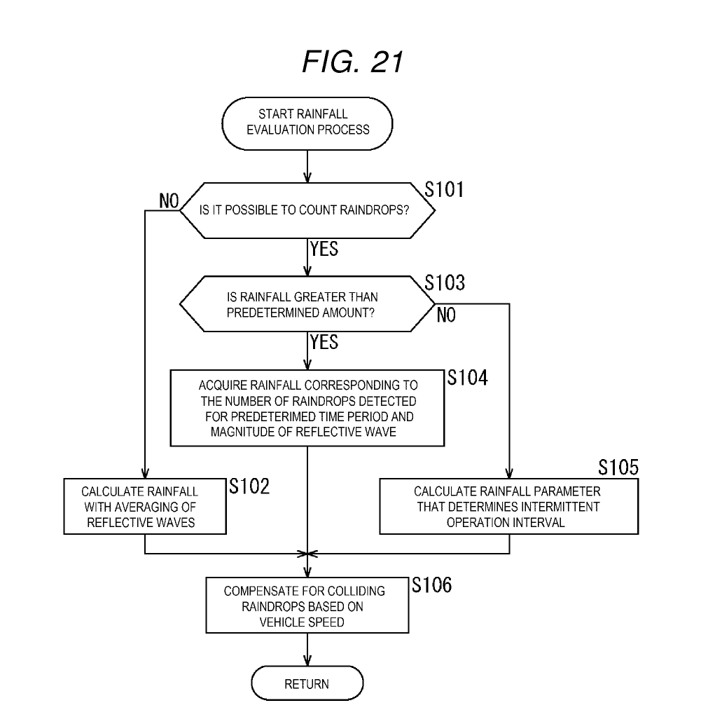

The raindrop sensor control unit 505 executes various processes, for example, a raindrop detection wiper control process illustrated in FIG. 13, a raindrop detecting process illustrated in FIG. 14, and a rainfall evaluation process illustrated in FIG. 21, all of which will be described later, based on the beam reception level supplied from the raindrop sensor beam receiving unit 501. The raindrop sensor control unit 505 supplies the respective process results of these processes to the determination processing unit 502 and the wiper operation control unit 504.

The wiper drive unit 512 drives the wiper (not illustrated) in accordance with control executed by the wiper operation control unit 504.

For example, the driver operates the wiper switch 511 so as to manually turn on and off the drive of the wiper.

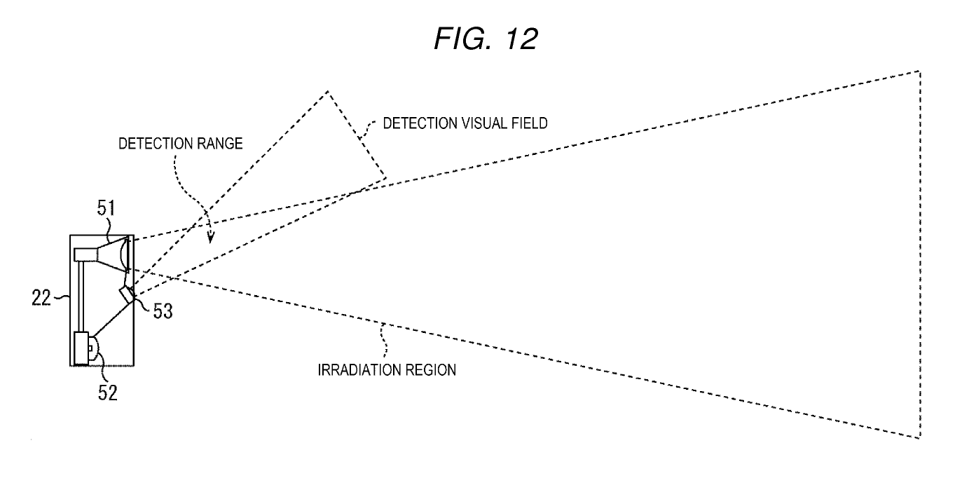

A detection range of the raindrop sensor 53 will be described with reference to FIG. 12.

In FIG. 12, dotted lines indicate an irradiation range of laser beams projected from the beam projecting unit 51, and a detection visual field in which the raindrop sensor beam receiving unit 501 of the raindrop sensor 53 can detect reflective waves, respectively. A detection range is a region in which the irradiation range and the detection visual field overlap each other. It is possible to appropriately set the detection range by adjusting the orientation of the raindrop sensor beam receiving unit 501 with respect to an optical axis of the beam projecting unit 51. For example, the detection range is set in a predetermined range (specifically, a range of approximately a few cm to 1 m from the front windshield glass 21) in front of the front windshield glass 21 of the vehicle 11.

Accordingly, the raindrop sensor 53 can detect raindrops in a predetermined range in front of the front windshield glass 21, that is, the raindrop sensor 53 can detect raindrops before the raindrops collide with the front windshield glass 21.

### Raindrop Detection Wiper Control Process of Laser Radar Apparatus

Subsequently, the raindrop detection wiper control process by the raindrop sensor 53 will be described with reference to a flow chart illustrated in FIG. 13.

For example, when the ignition is ON, and the vehicle 11 can travel, a process starts based on an operation start signal. In step S11, the raindrop sensor control unit 505 determines whether an automatic wiper function is ON so as to automatically operate the wiper of the vehicle 11.

When the raindrop sensor control unit 505 determines that the automatic wiper function is ON in step S11, the process proceeds to step S12. In step S12, the raindrop detecting process (a process illustrated in a flow chart of FIG. 14 which will be described later) is executed to detect raindrops in the detection range as illustrated in FIG. 12, and the process proceeds to step S13 after the raindrop detecting process is complete. For example, in the raindrop detecting process, when reflective waves of raindrops are detected based on the beam reception level output from the raindrop sensor beam receiving unit 501, a detection result that the raindrops are detected is obtained.

In step S13, the raindrop sensor control unit 505 determines whether the wiper is in operation.

In step S13, when the raindrop sensor control unit 505 determines that the wiper is not in operation, the process proceeds to step S14, and the raindrop sensor control unit 505 determines whether the detection result acquired in the raindrop detecting process of step S12 indicates the detection of the raindrops.

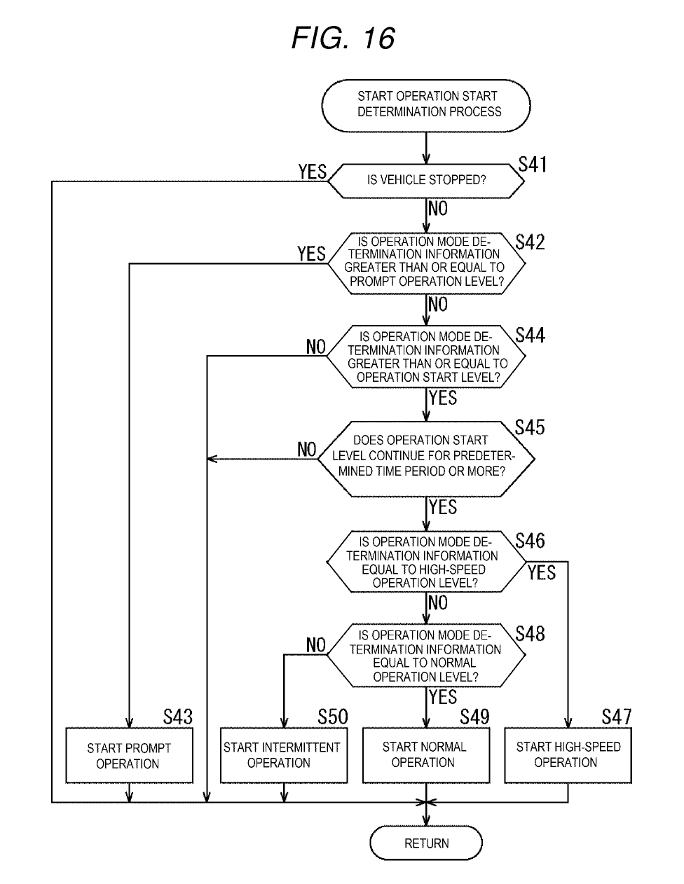

In step S14, when the raindrop sensor control unit 505 determines that the raindrops are detected, the process proceeds to step S15. That is, at this time, the wiper is not in operation, but the raindrops are detected. Accordingly, in step S15, the operation start determination process (a process illustrated in a flow chart of FIG. 16 which will be described later) is executed to determine whether to start a wiper operation.

In contrast, in step S13, when the raindrop sensor control unit 505 determines that the wiper is in operation, the process proceeds to step S16, and the raindrop sensor control unit 505 determines whether the detection result acquired in the raindrop detecting process of step S12 indicates the detection of the raindrops.

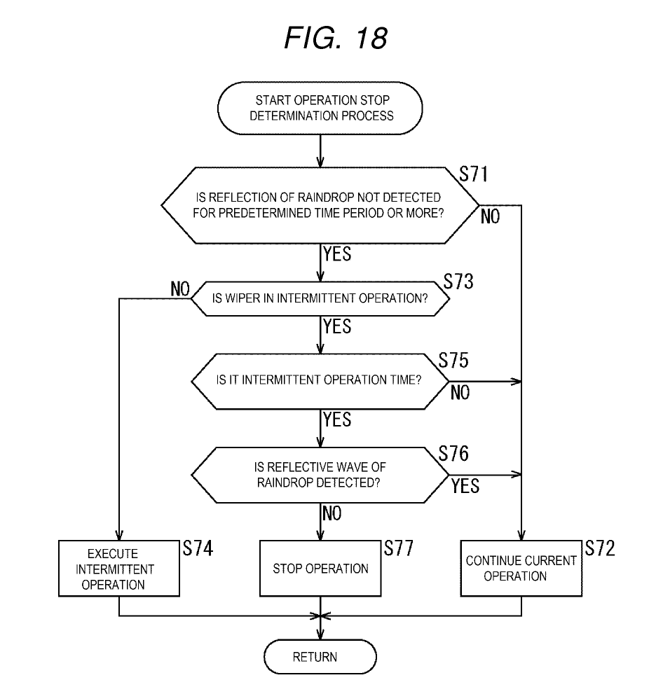

In step S16, when the raindrop sensor control unit 505 determines that the raindrops are not detected, the process proceeds to step S17. That is, at this time, the wiper is in operation, but the raindrops are not detected. Accordingly, in step S17, the operation stop determination process (a process illustrated in a flow chart of FIG. 18 which will be described later) is executed to determine whether to stop the wiper operation.

In contrast, in step S16, when the raindrop sensor control unit 505 determines that the raindrops are detected, the process proceeds to step S18. That is, at this time, the raindrops are detected while the wiper is in operation. In step S18, the rainfall evaluation process (a process illustrated in a flow chart of FIG. 21 which will be described later) is executed to evaluate rainfall based on the raindrops detected in the detection range, and the process proceeds to step S19 after the rainfall evaluation process is complete.

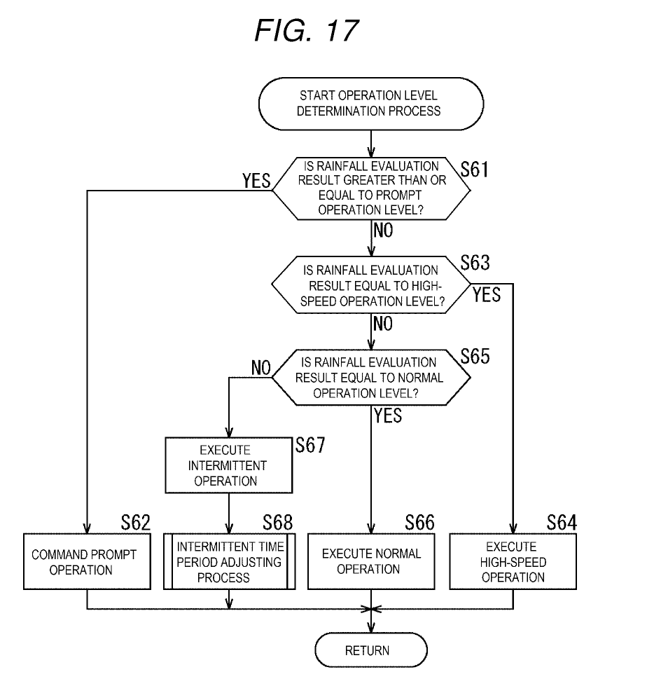

In step S19, the operation level determination process (a process illustrated in a flow chart of FIG. 17 which will be described later) is executed to determine an operation level-based wiper operation mode based on a rainfall evaluation result of the rainfall evaluation process in step S18.

After the operation start determination process in step S15, the operation stop determination process in step S17, and the operation level determination process in step S19 are complete, the process proceeds to step S21. In step S11, when the raindrop sensor control unit 505 determines that the automatic wiper function is not ON, the process proceeds to step S20. In step S20, even when the raindrop sensor control unit 505 determines that the wiper is in operation, the process proceeds to step S21.

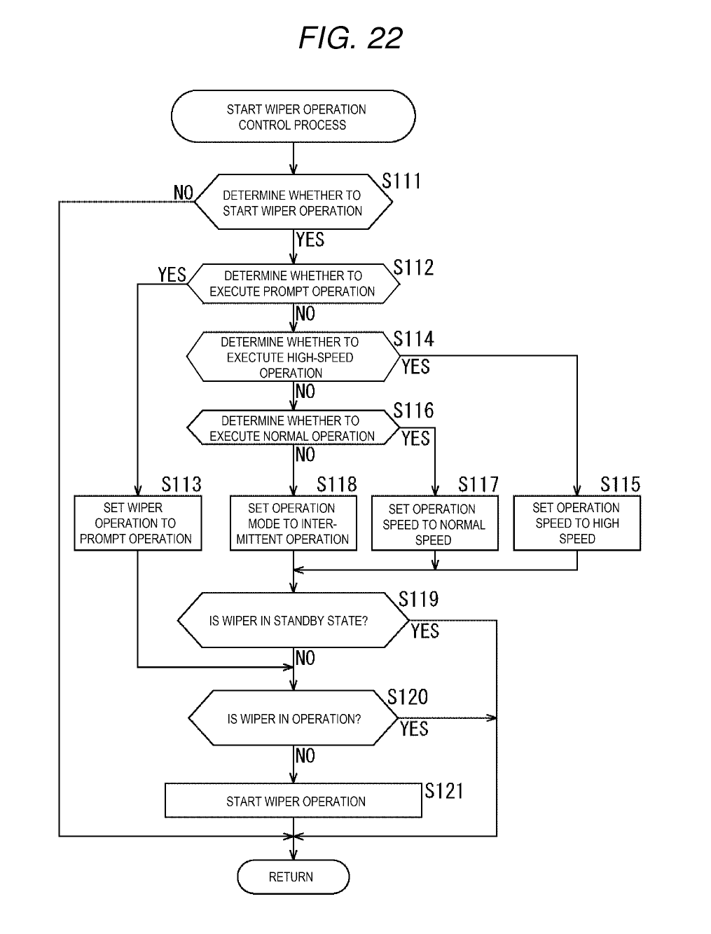

In step S21, the wiper operation control process (a process illustrated in a flow chart of FIG. 22 which will be described later) is executed to control the wiper operation, and the process proceeds to step S22 after the wiper operation control process is complete. In step S14, even when it is determined that the raindrops are not detected, the process proceeds to step S22. In step S20, even when it is determined whether the wiper is in operation, and then it is determined that the wiper is not in operation, the process proceeds to step S22.

In step S22, when the raindrop sensor control unit 505 determines whether the raindrop detection wiper control process ends, and determines that the raindrop detection wiper control process is not complete, the process returns to step S11, and then, the same process is repeated. In contrast, in step S22, when the raindrop sensor control unit 505 determines that the raindrop detection wiper control process ends, the raindrop detection wiper control process ends.

Subsequently, FIG. 14 is a flow chart describing the raindrop detecting process executed in step S12 of FIG. 13.

In step S31, the raindrop sensor control unit 505 controls the beam projecting unit 51 to repeatedly project pulse-shaped laser beams to a predetermined range in the vicinity of the front windshield glass 21, and the beam projecting unit 51 correspondingly projects laser beams.

In step S32, the raindrop sensor beam receiving unit 501 receives reflective waves of the laser beams projected in step S31, and supplies a beam reception level of the received reflective waves to the raindrop sensor control unit 505 and the determination processing unit 502.

In step S33, the raindrop sensor control unit 505 determines whether the beam reception level supplied from the raindrop sensor beam receiving unit 501 in step S32 is greater than or equal to a preset threshold value that indicates a boundary value at which it is possible to determine that the beam reception level is the reflective waves resulting from raindrops.

In step S33, when the raindrop sensor control unit 505 determines that the beam reception level is not greater than or equal to the threshold value, the process proceeds to step S34. That is, at this time, the raindrop sensor beam receiving unit 501 detects the reflective waves, but the beam reception level does not reach a beam reception level that is detectable when reflective waves resulting from raindrops are received. In step S34, the raindrop sensor control unit 505 calculates a background noise level based on the beam reception level supplied from the raindrop sensor beam receiving unit 501 in step S32.

In contrast, in step S33, when the raindrop sensor control unit 505 determines that the beam reception level is greater than or equal to the threshold value, the process proceeds to step S35. In step S35, the raindrop sensor control unit 505 stores the beam reception level detected by the raindrop sensor beam receiving unit 501 in a current raindrop detecting process as a beam reception level result that is detectable when the raindrop sensor beam receiving unit 501 receives reflective waves resulting from raindrops.

In step S36, the raindrop sensor control unit 505 determines whether the drive mode of the vehicle 11 is set to a snow mode that is suitable for driving in snow. For example, in the vehicle 11, the driver can set the drive mode of the vehicle 11 via the operation of an operation unit (not illustrated). In step S36, when the raindrop sensor control unit 505 determines that the drive mode of the vehicle 11 is not set to the snow mode, the process proceeds to step S37.

In step S37, the raindrop sensor control unit 505 determines whether the beam reception level result of the last raindrop detecting process indicates the beam reception level that is detectable when the raindrop sensor beam receiving unit 501 receives reflective waves resulting from raindrops.

In step S37, when the raindrop sensor control unit 505 determines that the beam reception level result of the last raindrop detecting process does not indicate the beam reception level that is detectable when the raindrop sensor beam receiving unit 501 receives reflective waves resulting from raindrops, the process proceeds to step S38. In step S36, even when it is determined that the drive mode of the vehicle 11 is set to the snow mode, the process proceeds to step S38.

In step S38, the raindrop sensor control unit 505 determines that the beam reception level detected by the raindrop sensor beam receiving unit 501 can be obtained when reflective waves result from raindrops. Accordingly, a detection result in which the raindrops are detected in the raindrop detecting process is acquired.

In contrast, in step S37, when the raindrop sensor control unit 505 determines that the beam reception level result of the last raindrop detecting process indicates the beam reception level that is detectable when the raindrop sensor beam receiving unit 501 receives reflective waves resulting from raindrops, the process proceeds to step S39.

In step S39, the raindrop sensor control unit 505 determines that the beam reception level detected by the raindrop sensor beam receiving unit 501 can be obtained when reflective waves result from dust.

After the process in step S34, step S38, or step S39 is complete, the raindrop detecting process ends, and the process proceeds to step S13 in FIG. 13. When a background noise level is calculated in step S34, or when it is determined that the beam reception level results from the reflection by dust in step S39, a detection result of the raindrop detecting process indicates that raindrops are not detected.

As described above, in the raindrop detecting process, the beam projecting unit 51 repeatedly projects pulse-shaped laser beams from the inner side of the front windshield glass 21, and the raindrop sensor beam receiving unit 501 receives reflective waves and measures a beam reception level.

Accordingly, the raindrop sensor 53 can detect each raindrop, and for example, even when the glass surface is uniformly wet with a large amount of raindrops, the raindrop sensor 53 can reliably detect the raindrops. The raindrop sensor 53 can detect raindrops before the raindrops are attached to the glass, and it is possible to prevent a delay in detecting the raindrops.

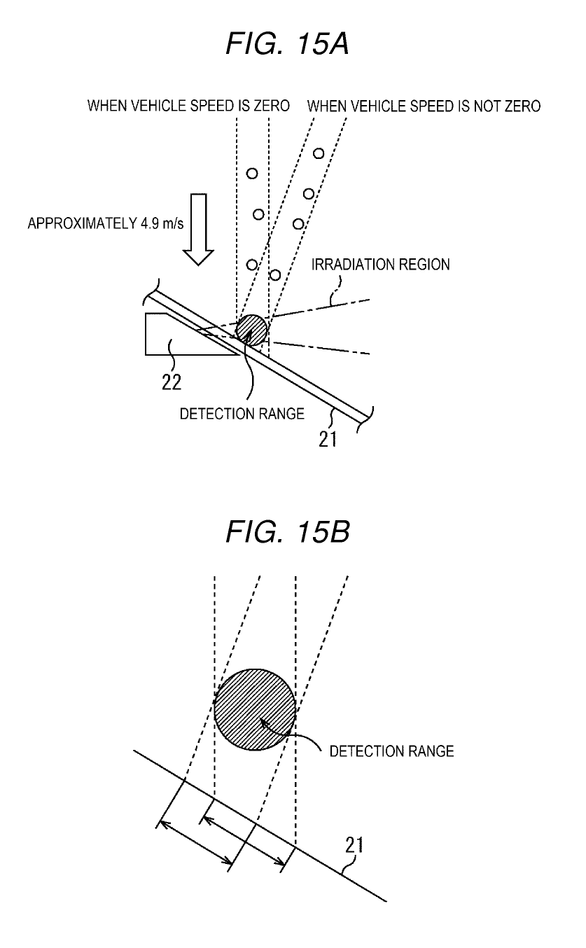

Here, a process of determining whether there are raindrops will be described with reference to FIGS. 15A and 16B.

A laser radar method may detect beams reflected from dust floating in the air or an insect, and when the beams reflected from the dust or the insect are detected, it is undesirable to operate the wiper. Since a raindrop falls due to gravity, as illustrated in FIGS. 15A and 15B, the raindrop falls at approximately 4.9 m per second.

Accordingly, when the detection range is adjusted along a falling direction of the raindrop, the laser radar apparatus 22 can detect one raindrop only once. For this reason, in step S37 of FIG. 14, when the raindrop sensor control unit 505 determines that the beam reception level result of the last raindrop detecting process indicates the beam reception level that is detectable when the raindrop sensor beam receiving unit 501 receives reflective waves resulting from raindrops, and the same beam reception level is continuously detected, the raindrop sensor control unit 505 determines that the reflective waves result from dust floating in the air.

In step S37 of FIG. 14, when the raindrop sensor control unit 505 determines that the beam reception level result of the last raindrop detecting process does not indicate the beam reception level that is detectable when the raindrop sensor beam receiving unit 501 receives reflective waves resulting from raindrops, and the same beam reception level is not continuously detected, the raindrop sensor control unit 505 determines that a falling raindrop is detected only once.

When it snows, each snowflake is detected similar to dust. When it is determined that the drive mode of the vehicle 11 is set to the snow mode, the raindrop sensor control unit 505 can be prevented from determining that there is dust, and can determine that there are raindrops.

As illustrated in FIG. 15A, concerning a direction in which a raindrop comes toward the front windshield glass 21, the direction of the raindrop when the speed of the vehicle 11 is zero is different from that when the speed of the vehicle 11 is not zero. For this reason, as illustrated in FIG. 15B, even when the raindrop passes through the same detection range, the raindrop collides with the front windshield glass 21 at different positions. For example, when a time period from the detection of raindrops to the start of a wiper operation is adjusted based on the speed of the vehicle 11, the raindrop sensor 53 can control the wiper operation in such a manner that the raindrops are wiped away at an appropriate time after the raindrops collide with the front windshield glass 21.

Subsequently, FIG. 16 is a flow chart describing the operation start determination process executed in step S15 of FIG. 13.

In step S41, for example, the operation start determination unit 521 determines whether the vehicle 11 is stopped based on the speed of the host vehicle supplied from the speed measurement apparatus (not illustrated) via the raindrop sensor control unit 505.

In step S41, when the operation start determination unit 521 illustrated in FIG. 11 determines that the vehicle 11 is not stopped, that is, when the speed of the vehicle 11 is greater than or equal to zero, the process proceeds to step S42.

In step S42, the operation start determination unit 521 determines whether operation mode determination information is greater than or equal to a prompt operation level so as to determine a wiper operation mode at its start. Here, for example, the operation mode determination information is based on a beam reception level detected in the raindrop detecting process that has been described in detail with reference to FIG. 14.

In step S42, when the operation start determination unit 521 determines that the operation mode determination information is greater than or equal to the prompt operation level, the process proceeds to step S43. In step S43, the operation start determination unit 521 determines the starting of a prompt wiper operation as a determination result of the operation start determination process.

In contrast, in step S42, when the operation start determination unit 521 determines that the operation mode determination information is not greater than or equal to the prompt operation level (that is, less than the prompt operation level), the process proceeds to step S44. In step S44, the operation start determination unit 521 determines whether the operation mode determination information is greater than or equal to an operation start level, and when it is determined that the operation mode determination information is greater than or equal to the operation start level, the process proceeds to step S45.

In step S45, the operation start determination unit 521 determines whether the operation mode determination information is continuously greater than or equal to an operation start level for a predetermined time period or more, and when it is determined that the operation mode determination information is continuously greater than or equal to the operation start level for a predetermined time period or more, the process proceeds to step S46. In step S46, the operation start determination unit 521 determines whether the operation mode determination information is equal to a high-speed operation level.

In step S46, when the operation start determination unit 521 determines that the operation mode determination information is equal to the high speed-operation level, the process proceeds to step S47. In step S47, the operation start determination unit 521 determines the starting of a high-speed wiper operation as a determination result of the operation start determination process.

In contrast, in step S46, when the operation start determination unit 521 determines that the operation mode determination information is not equal to the high speed-operation level, the process proceeds to step S48. In step S48, the operation start determination unit 521 determines whether the operation mode determination information is equal to a normal operation level.

In step S48, when the operation start determination unit 521 determines that the operation mode determination information is equal to the normal operation level, the process proceeds to step S49. In step S49, the operation start determination unit 521 determines the starting of a normal wiper operation as a determination result of the operation start determination process.

In contrast, in step S48, when the operation start determination unit 521 determines that the operation mode determination information is not equal to the normal operation level, the process proceeds to step S50. In step S50, the operation start determination unit 521 determines the starting of an intermittent wiper operation as a determination result of the operation start determination process.

When the determination result of the operation start determination process in step S43, step S47, step S49, or step S50 is determined, the operation start determination process ends, and the process returns to step S21 in FIG. 13.

Even when it is determined that the vehicle 11 is stopped in step S41 (that is, when the speed of the vehicle 11 is zero), even when it is determined that the operation mode determination information is not greater than or equal to the operation start level in step S44, or even when it is determined that the operation mode determination information is not continuously greater than or equal to the operation start level for a predetermined time period or more in step S45, the operation start determination process ends, and the process returns to step S21 in FIG. 13. At this time, a determination result of the operation start determination process is the non-starting of a wiper operation.

As described above, in the operation start determination process, a determination result for indicating a wiper operation mode (the prompt operation, the high-speed operation, the normal operation, or the intermittent operation) at its start is determined based on the operation mode determination information.

When a person wipes the front windshield glass 21 with a dustcloth, the raindrop sensor beam receiving unit 501 detects reflective beams similar to when a large amount of water is scattered on the font windshield glass 21. In the operation start determination process, when the speed of the vehicle 11 is zero, a wiper operation is controlled not to start in such a manner that the wiper operation is prevented from starting when this state is detected.

In the operation start determination process, when the operation mode determination information is continuously greater than or equal to the operation start level for a predetermined time period or more, a wiper operation is controlled to start in any one of the operation modes. In contrast, when the operation mode determination information is less than the operation start level, or when the operation mode determination information is not continuously greater than or equal to the operation start level for a predetermined time period or more, a wiper operation is controlled not to start.

Subsequently, FIG. 17 illustrates a flow chart describing the operation level determination process executed in step S19 of FIG. 13.

In step S61, the operation level determination unit 522 illustrated in FIG. 11 determines whether a rainfall evaluation result is greater than or equal to the prompt operation level. The rainfall evaluation result is acquired in the rainfall evaluation process (a process illustrated in a flow chart of FIG. 21 which will be described later) in step S18 of FIG. 13.

In step S61, when the operation level determination unit 522 determines that the rainfall evaluation result is greater than or equal to the prompt operation level, the process proceeds to step S62. In step S62, the operation level determination unit 522 determines a command of the prompt wiper operation as a determination result of the operation level determination process.

In contrast, in step S61, when the operation level determination unit 522 determines that the rainfall evaluation result is not greater than or equal to the prompt operation level (that is, less than the prompt operation level), the process proceeds to step S63.

In step S63, the operation level determination unit 522 determines whether the rainfall evaluation result is within a range of the high-speed operation level.

In step S63, when the operation level determination unit 522 determines that the rainfall evaluation result is within a range of the high-speed operation level, the process proceeds to step S64. In step S64, the operation level determination unit 522 determines the execution of the high-speed wiper operation as a determination result of the operation level determination process.

In contrast, in step S63, when the operation level determination unit 522 determines that the rainfall evaluation result is not within a range of the high-speed operation level (that is, outside of a range of the high-speed operation level), the process proceeds to step S65.

In step S65, the operation level determination unit 522 determines whether the rainfall evaluation result is within a range of the normal operation level.

In step S65, when the operation level determination unit 522 determines that the rainfall evaluation result is within a range of the normal operation level, the process proceeds to step S66. In step S66, the operation level determination unit 522 determines the execution of the normal wiper operation as a determination result of the operation level determination process.

In contrast, in step S65, when the operation level determination unit 522 determines that the rainfall evaluation result is not within a range of the normal operation level (that is, outside of a range of the normal operation level), the process proceeds to step S67. In step S67, the operation level determination unit 522 determines the execution of the intermittent wiper operation as a determination result of the operation level determination process.

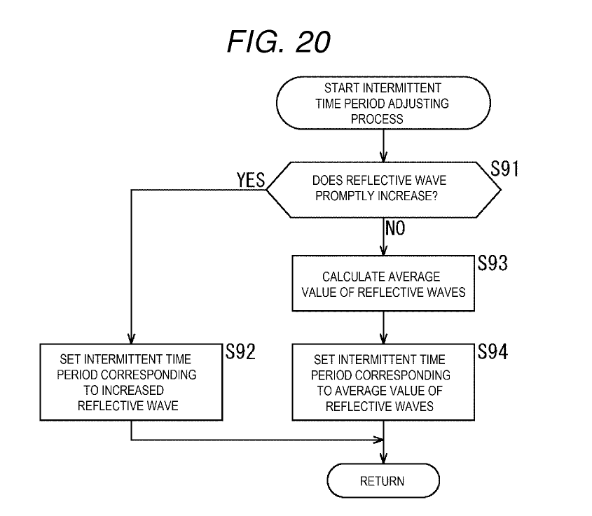

In step S68, since it is determined that the intermittent wiper operation is executed, the wiper operation control unit 504 illustrated in FIG. 11 executes an intermittent time period adjusting process (a process illustrated in a flow chart of FIG. 20 which will be described later) so as to adjust an intermittent time period for which the wiper stops and is in a standby state in the intermittent wiper operation.

When the determination result of the operation level determination process in step S62, step S64, or step S66 is determined, the operation level determination process ends, and the process returns to step S21 in FIG. 13. Alternatively, when the determination result of the operation level determination process is determined in step S67, and then, the intermittent time period adjusting process in step S68 ends, the operation level determination process ends, and the process returns to step S21 in FIG. 13.

As described above, in the operation level determination process, a determination result for indicating a wiper operation mode (the prompt operation, the high-speed operation, the normal operation, or the intermittent operation) is determined based on the rainfall evaluation result. For example, in the operation stop determination process, when reflective waves from a large amount of raindrops are detected for a short time period, for example, when a truck passes by the host vehicle, and splashes a large amount of water over the host vehicle, it is possible to execute control for effectively wiping away water by outputting a command of the prompt wiper operation.

Subsequently, FIG. 18 is a flow chart describing the operation stop determination process executed in step S17 of FIG. 13.

In step S71, the operation stop determination unit 523 illustrated in FIG. 11 determines whether the reflection of raindrops is not detected for a predetermined time period or more, based on a raindrop detection result of the raindrop detecting process in step S12 of FIG. 13.

In step S71, when the operation stop determination unit 523 determines that the reflection of raindrops is detected for a predetermined time period or more, the process proceeds to step S72. In step S72, the operation stop determination unit 523 determines the continuous execution of a wiper operation in a current wiper operation mode as a determination result of the operation stop determination process.

In contrast, in step S71, when the operation stop determination unit 523 determines that the reflection of raindrops is not detected for a predetermined time period or more, the process proceeds to step S73, and the operation stop determination unit 523 determines whether the wiper is in the intermittent operation.

In step S73, when the operation stop determination unit 523 determines that the wiper is not in the intermittent operation, that is, a current wiper operation mode is not the intermittent operation, the process proceeds to step S74. In step S74, the operation stop determination unit 523 determines the execution of the intermittent wiper operation, that is, a wiper operation mode being set to the intermittent operation as a determination result of the operation stop determination process.

In contrast, in step S73, when the operation stop determination unit 523 determines that the wiper is in the intermittent operation, the process proceeds to step S75, and the operation stop determination unit 523 determines whether it is intermittent operation time when the intermittent wiper operation is executed.

In step S75, when the operation stop determination unit 523 determines that it is not the intermittent operation time, the process proceeds to step S72. In step S72, the operation stop determination unit 523 determines the continuous execution of the wiper operation in the current wiper operation mode, that is, the continuous execution of the intermittent wiper operation as the determination result of the operation stop determination process.

In contrast, in step S75, when the operation stop determination unit 523 determines that it is the intermittent operation time, the process proceeds to step S76, and the operation stop determination unit 523 determines whether the reflective waves of raindrops are detected.

In step S76, when the operation stop determination unit 523 determines that the reflective waves of raindrops are detected, the process proceeds to step S72. In step S72, the operation stop determination unit 523 determines the continuous execution of the wiper operation in the current wiper operation mode, that is, the continuous execution of the intermittent wiper operation as the determination result of the operation stop determination process.

In contrast, in step S76, when the operation stop determination unit 523 determines that the reflective waves of raindrops are not detected, the process proceeds to step S77. In step S77, the operation stop determination unit 523 determines the stopping of a wiper operation as a determination result of the operation stop determination process.

After the determination result of the operation stop determination process in step S72, step S74, or step S77 is determined, the operation stop determination process ends, and the process returns to step S21 in FIG. 13.

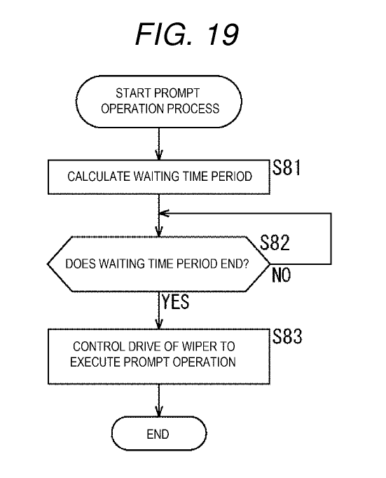

Subsequently, FIG. 19 is a flow chart describing a prompt operation process executed by the wiper drive unit 512 when the starting of the prompt wiper operation is determined as the determination result in step S43 of FIG. 16, or when a command of the prompt wiper operation is determined as the determination result in step S62 of FIG. 17. The prompt operation process is executed as a separate task from the raindrop detection wiper control process in FIG. 13.

In step S81, the wiper drive unit 512 calculates a waiting time period until the wiper operates promptly. For example, a time period until the wiper wipes away raindrops is subtracted from a time period until the raindrops collide with the front windshield glass 21, thereby obtaining the waiting time period. When the waiting time period obtained in this manner is a negative value, the wiper drive unit 512 sets the waiting time period to zero.

In step S82, the wiper drive unit 512 determines whether the waiting time period calculated in step S81 ends, and the process is in a standby state until it is determined that the waiting time ends.

In step S82, when it is determined that the waiting time period ends, the process proceeds to step S83, and the wiper drive unit 512 controls the drive of the wiper to execute the prompt operation, and the prompt operation process ends.

As described above, in the vehicle 11, when the prompt wiper operation is executed, control is executed to delay a wiper operation based on the waiting time period obtained in the above-mentioned manner. Accordingly, it is possible to control a wiper operation to be executed at an appropriate time, that is, it is possible to control the wiper operation in such a manner that the front windshield glass 21 is wiped after becoming wet. The raindrop sensor 53 can delay a wiper operation based on the traveling speed of the vehicle 11 and a wiper operation start delay time period, that is, the raindrop sensor 53 can determine the operation start time, and operate the wiper at the optimum operation time.

Subsequently, FIG. 20 is a flow chart describing the intermittent time period adjusting process executed in step S68 of FIG. 17.

In step S91, the wiper operation control unit 504 determines whether reflective waves of raindrops detected in the raindrop detecting process are promptly increased, based on the raindrop detection result of the raindrop detecting process in step S12 of FIG. 13.

In step S91, when the wiper operation control unit 504 determines that the reflective waves of raindrops detected in the raindrop detecting process are promptly increased, the process proceeds to step S92. In step S92, the wiper operation control unit 504 sets the intermittent time period for the intermittent wiper operation to a time period that corresponds to the increased reflective waves of raindrops.

In contrast, in step S91, when the wiper operation control unit 504 determines that the reflective waves of raindrops detected in the raindrop detecting process are not promptly increased, the process proceeds to step S93, and the wiper operation control unit 504 calculates an average value of the reflective waves of raindrops detected in the raindrop detecting process.

In step S94, the wiper operation control unit 504 sets the intermittent time period for the intermittent wiper operation to a time period that corresponds to the average value of the reflective waves calculated in step S93.

In step S92 or step S94, after the intermittent time period is set for the intermittent wiper operation, the intermittent time period adjusting process ends.

Subsequently, FIG. 21 is a flow chart describing the rainfall evaluation process executed in step S18 of FIG. 13.

In step S101, the raindrop sensor control unit 505 determines whether it is possible to count raindrops, based on a change in a beam reception level supplied from the raindrop sensor beam receiving unit 501. For example, when a change in the beam reception level is large, the raindrop sensor control unit 505 determines that it is possible to count raindrops.

In step S101, when the raindrop sensor control unit 505 determines that it is not possible to count raindrops, the process proceeds to step S102. In step S102, the raindrop sensor control unit 505 calculates rainfall by averaging reflective waves of raindrops based on a beam reception level supplied from the raindrop sensor beam receiving unit 501, and acquires the calculated rainfall as an evaluation result of the rainfall evaluation process.

In contrast, in step S101, when the raindrop sensor control unit 505 determines that it is possible to count raindrops, the process proceeds to step S103, and the raindrop sensor control unit 505 determines whether the rainfall is greater than a predetermined amount. For example, when the peak of reflective waves of raindrops is greater than a predetermined threshold value, the raindrop sensor control unit 505 determines that the rainfall is greater than or equal to a predetermined amount.

In step S103, when the raindrop sensor control unit 505 determines that the rainfall is greater than a predetermined amount, the process proceeds to step S104. In step S104, the raindrop sensor control unit 505 acquires as an evaluation result of the rainfall evaluation process, rainfall that corresponds to the number of raindrops detected for a predetermined time period and the respective magnitudes of the reflective waves.

In contrast, in step S103, when the raindrop sensor control unit 505 determines that the rainfall is not greater than a predetermined amount (that is, is less than or equal to a predetermined amount), the process proceeds to step S105. In step S105, the raindrop sensor control unit 505 calculates a rainfall parameter that determines an intermittent wiper operation interval, and acquires the rainfall parameter as an evaluation result of the rainfall evaluation process.

After the process in step S102, step S104, or S105 is complete, the process proceeds to step S106, and the raindrop sensor control unit 505 compensates for colliding raindrops based on the speed of the vehicle 11. For example, when the laser beam projecting and receiving ranges of the laser radar apparatus 22 are wide, it is necessary to compensate for colliding raindrops.

After the process in step S106 is complete, the rainfall evaluation process ends, and the process returns to step S19 in FIG. 13.

As described above, in the rainfall evaluation process, raindrops are detected one by one, and a reflective wave is detected in proportion to the size of a raindrop, and thus it is possible to calculate rainfall from the number of raindrops detected for a predetermined time period (for example, for one second) and the intensity of reflective beams. For example, when raindrops are fire, and rainfall is large, the level of reflective waves increases on average, and thus it is possible to calculate the rainfall from an average level of the reflective waves in the rainfall evaluation process.

Subsequently, FIG. 22 is a flow chart describing a wiper operation control process executed in step S21 of FIG. 13.

In step S111, the wiper operation control unit 504 determines whether to start a wiper operation based on a determination result of the operation start determination process in step S15 of FIG. 13.

In step S111, when the wiper operation control unit 504 determines the starting of the wiper operation, the process proceeds to step S112, and the wiper operation control unit 504 determines whether to execute the prompt wiper operation. For example, when the determination result of the operation start determination process in FIG. 16 indicates the starting of the prompt wiper operation, or when the determination result of the operation level determination process in FIG. 17 indicates a command of the prompt wiper operation, the wiper operation control unit 504 determines the execution of the prompt wiper operation.

In step S112, when the wiper operation control unit 504 determines the execution of the prompt wiper operation, the process proceeds to step S113. In step S113, the wiper operation control unit 504 controls the wiper drive unit 512 to operate the wiper in the prompt operation mode.

In contrast, in step S112, when the wiper operation control unit 504 determines the non-execution of the prompt wiper operation, the process proceeds to step S114, and the wiper operation control unit 504 determines whether to execute the high-speed wiper operation. For example, when the determination result of the operation start determination process in FIG. 16 indicates the starting of the high-speed wiper operation, or when the determination result of the operation level determination process in FIG. 17 indicates the execution of the high-speed wiper operation, the wiper operation control unit 504 determines the execution of the high-speed wiper operation.

In step S114, when the wiper operation control unit 504 determines the execution of the high-speed wiper operation, the process proceeds to step S115. In step S115, the wiper operation control unit 504 controls the wiper drive unit 512 to operate the wiper in the high-speed operation mode.

In contrast, in step S114, when the wiper operation control unit 504 determines the non-execution of the high-speed wiper operation, the process proceeds to step S116, and the wiper operation control unit 504 determines whether to execute the normal wiper operation. For example, when the determination result of the operation start determination process in FIG. 16 indicates the starting of the normal wiper operation, or when the determination result of the operation level determination process in FIG. 17 indicates the execution of the normal wiper operation, the wiper operation control unit 504 determines the execution of the normal wiper operation.

In step S116, when the wiper operation control unit 504 determines the execution of the normal wiper operation, the process proceeds to step S117. In step S117, the wiper operation control unit 504 controls the wiper drive unit 512 to operate the wiper in the normal operation mode.

In contrast, in step S116, when the wiper operation control unit 504 determines the non-execution of the normal wiper operation, the process proceeds to step S118. In step S118, the wiper operation control unit 504 controls the wiper drive unit 512 to operate the wiper in the intermittent operation mode.

After the process in step S115, step S117, or step S118 is complete, the process proceeds to step S119, and the wiper operation control unit 504 determines whether the wiper is in a standby state.

In step S119, when the wiper operation control unit 504 determines that the wiper is not in a standby state, the process proceeds to step S120. Even after the process in step S113 is complete, the process proceeds to step S120.

In step S120, the wiper operation control unit 504 determines whether the wiper is in operation, and when it is determined that the wiper is not in operation, the process proceeds to step S121. In step S121, the wiper drive unit 512 drives the starting of a wiper operation based on control from the wiper operation control unit 504 in any one of step S113, step S115, step S117, and step S118.

When the wiper operation starts in the process of step S121, the wiper operation control process ends. When it is determined that the wiper operation does not start in step S111, when it is determined that the wiper is in a standby state in step S119, or when it is determined that the wiper is in operation in step S120, the wiper operation control process ends.

As described above, the wiper operation control unit 504 can control the wiper to operate in an appropriate operation mode based on the determination result of the operation start determination process in FIG. 16, or the determination result of the operation level determination process in FIG. 17.

It is possible to execute the entirety of a series of processes described above via not only hardware but also software. For example, when the series of processes are executed via software, a program designed to configure the software is installed from a recording media into a computer built with exclusive hardware, or a versatile personal computer or the like in which various programs are installed and various functions can be executed.

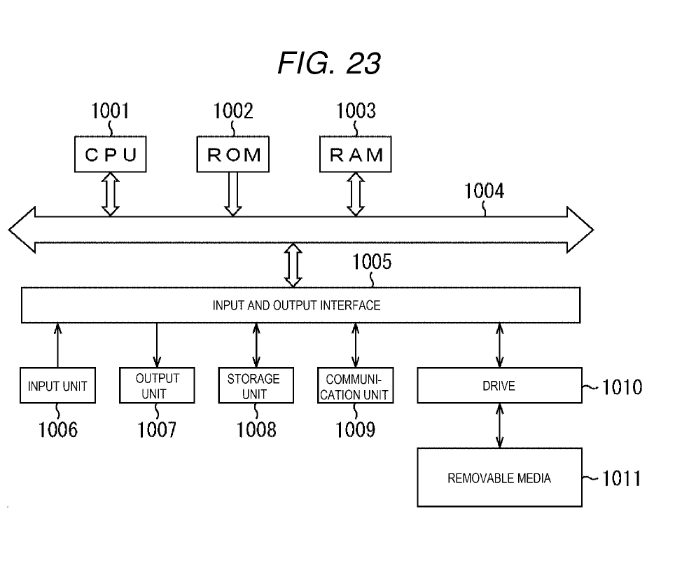

FIG. 23 illustrates an example of the configuration of the versatile personal computer. The personal computer has a built-in central processing unit (CPU) 1001. The CPU 1001 is connected to an input and output interface 1005 via a bus 1004. The bus 1004 is connected to a read only memory (ROM) 1002 and a random access memory (RAM) 1003.

The input and output interface 1005 is connected to an input unit 1006 that includes input devices such as a keyboard, a mouse, and the like through which a user inputs an operation command; an output unit 1007 that outputs a process operation screen or an image of a process result on a display device; a storage unit 1008 that includes a hard disc drive and the like which stores a program or various data; and a communication unit 1009 that includes a local area network (LAN) adapter and the like, and executes a communication process via the internet representative of a network. The input and output interface 1005 is connected to a drive 1010 that reads data from and writes on a removable media 1011 such as a magnetic disc (including a flexible disc), an optical disc (including compact disc-read only memory (CD-ROM) and a digital versatile disc (DVD)), a magneto-optical disc (mini disc (MD)) or a semiconductor memory.

The CPU 1001 is caused to execute various processes by a program that is stored in the ROM 1002 and then is loaded in the RAM, or that is read from the removable media 1011 such as the magnetic disc, the optical disc, a magneto-optical disc, or the semiconductor memory, then is installed in the storage unit 1008, and then is loaded in the RAM 1003 from the storage unit 1008. In addition, the RAM 1003 appropriately stores data and the like required for the CPU 1001 to execute various processes.

In this specification, steps of describing a program stored on the recording media include not only processes executed in time series according to a recorded sequence, but also processes which are not executed in time series but are executed in parallel or individually.

In this specification, a system refers to the entirety of an apparatus which includes a plurality of apparatuses.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited by the attached claims.

What is claimed is:

1. A laser radar apparatus comprising:
a beam projecting unit that projects a pulse-shaped beam to an outside of a vehicle from an inside of the vehicle via a glass surface;
a beam receiving unit that is installed at a position separated from the beam projecting unit in a substantially horizontal direction, and receives via the glass surface a reflective wave occurring when the beam projected from the beam projecting unit is reflected from an object;
a control unit that commands a prompt operation mode of a wiper which wipes the glass surface when an amount of the objects is determined to be greater than or equal to a given level based on a beam reception level detected by the beam receiving unit; and
a wiper operation control unit that controls the wiper to operate in the prompt operation mode after a waiting time period elapses, the waiting time period being from when it is detected that the amount of the objects is greater than or equal to the given level to when a wiper operation starts.

2. The laser radar apparatus according to claim 1, further comprising:
an operation start determination unit that executes a determination process to prevent start of a wiper operation when it is determined that the vehicle is stopped.

3. The laser radar apparatus according to claim 1,
wherein when the beam reception level detected by the beam receiving unit is greater than or equal to a threshold value at which the detected beam reception level can be determined as a reflective wave occurring when the beam projected from the beam projecting unit is reflected from a raindrop, the control unit stores the beam reception level greater than or equal to the threshold value, and
wherein when a last beam reception level resulting from a beam projected in a pulse shape is less than the threshold value, the control unit determines that the object is the raindrop.

4. The laser radar apparatus according to claim 1,
wherein when a drive mode of the vehicle is set to a snow mode, the beam reception level detected by the beam receiving unit is greater than or equal to a threshold value at which the detected beam reception level can be determined as a reflective wave occurring when the beam projected from the beam projecting unit is reflected from a raindrop, the control unit determines that the object is the raindrop.

5. The laser radar apparatus according to claim 3,
wherein when it is determined that the object is the raindrop, the control unit evaluates rainfall based on the beam reception level detected by the beam receiving unit, and
wherein said laser radar apparatus further comprises:
an operation level determination unit that determines an operation level of the wiper based on a result of the rainfall evaluated by the control unit.

6. The laser radar apparatus according to claim 4,
wherein when it is determined that the object is the raindrop, the control unit evaluates rainfall based on the beam reception level detected by the beam receiving unit, and
wherein said laser radar apparatus further comprises:
an operation level determination unit that determines an operation level of the wiper based on a result of the rainfall evaluated by the control unit.
